(19) United States
(12) Patent Application Publication
(10) Pub. No.: US 2006/0007668 A1
(43) Pub. Date: Jan. 12, 2006

(54) LED button light kits for footwear

(76) Inventor: Tseng-Lu Chien, Shi-Chi Town (TW)

Correspondence Address: BACON & THOMAS, PLLC, 625 SLATERS LANE, FOURTH FLOOR, ALEXANDRIA, VA, 22314, US

(21) Appl. No.: 10/883,719

(22) Filed: Jul. 6, 2004

(51) Int. Cl. F21V 21/08

(52) U.S. Cl. 362/103

(57) ABSTRACT

The current invention incorporated with LED button light kits for footwear which consist a conventional button light kits which have the rich color and indicia, designs on the display surface with its variable base to fix on the different location of footwear such as shoe upper, outsole, bottom, walls, tongue as design requirement. The current invention applied these conventional LED button light for footwear to improvement the current LED lighted shoe's problems including the limited design, installation and ugly appearance. Furthermore, the current invention use desired switch means to prevent from the power consumption during the delivery.

This application is a continuation-in-part of flexible LED light kits for footwear and fiber optics light kits for footwear, both are filed into U.S. PTO on date.

### BACKGROUND OF THE INVENTION

The current invention relates to incorporate the marketing available LED button light to the all kind of footwear including beach sandal, indoor slipper, athletic shoe, bootie, causal shoe and other purpose shoe for people to wear. Furthermore, the current invention incorporate more technical to disclosure how to install the revised LED button light on shoe upper, outsole, bottom wall, lace, shoe tongue, it almost can install anywhere of the footwear.

The current invention make some revised from the LED button light but adapted its excellent design and rich color for the LED arrangement and whole treatment to make big improvement for the conventional LED light shoe with very ugly appearance and add the LED(s) light unit very roughly.

The current invention make some revised from the LED button light but adapted it for using the modern dice-type LED(s) use model technical to fix on the Printing circuit board (hereafter as PCB) and with a nice printing process to make the front surface with very rich color and shape. This is big improvement for conventional LED lighted shoe problem. Furthermore, for some special requirement, the LED button light PCB is rigid and can use the flexible printing circuit board (hereafter as FPC) to make the unit for bendable and flexible features.

The Flexible Printing Circuit (FPC) having the features for bending, flexible, durable so can let the LED(s) well install on these copper area(s). The dice or the Chips of LED having the super compact dimension so allow people can have the super narrow and flexible LED(s) panel such as the Dice can have dimension less than 3 mm and Chips also less than 7 mm so can have super narrow LED(s) Band or Board for variety application which can not do before.

The current invention incorporated the proper switch system to prevent from the power consumption during the delivery. The Current invention applied the marketing place available LED dice or chip applied to the FPC to create the flexible, bendable, durable LED(s) light kits incorporated with Integrated circuit and push on-off switch by weight to trigger the Integrated Circuit (hereafter as IC) for footwear which will prevent from the delivery battery power consumption which is major problem for prior art of the Mr. Nick Rogers and Mr. Wei etc. Both of the prior arts, the trigger by the vibration switch and the Integrated Circuit will be start to functions while the switch from away from the contact-position or while the switch touch the contact-position. After the triggered, the light functions will last for a period of time as pre-determined time. The current invention make big improvement from those prior arts basing on the Push on-off switch triggered IC by weight and stop while the weight is away from the push on-off switch instantly.

The current invention incorporated the install means for the LED button light so can simple and quickly install on footwear. Further, The current invention teach a weather protection for the flexible or rigid printing circuit board by injection process or by envelope process or by epoxy sealing, to make the cosmetic appearance so the dice or chip of LED(s) will not see by the viewers. Only the super bright and attractive motion light effects been seen from viewers.

Also, the current invention with special batteries arrangement for different voltage and amperage required by different colors LED(s). The co-inventor's prior art U.S. Pat. No. 5,599,088 disclosure polarity of batteries with combination of selection of connecting arrangement for desired voltage and amperage from in-series and in-parallel arrangement batteries.

The current invention incorporated the integrate circuit to make the power consumption and make the light have eye-catching effects and functions.

### BRIEF DESCRIPTION OF THE DRAWINGS

FIG. 1: Disclosure the 1^{st} embodiment for a beach sandal with preferred button LED(s) light kits which incorporating the epoxy sealing plurality of LED(s) within with eye-catching surface and envelope-process to sealed and hidden the wires of the shoe upper. The push on and off switch connected between the IC and power source to make the circuit with power or cut-off the power. The push on and off switch connected between the IC and power source to make the circuit with power or cut-off the power.

FIG. 1-1 to 1-11: Disclosure the different LED button light designs with build-in IC chip.

FIG. 2: Disclosure the different construction of the compartment design for different purpose to a display surface.

FIG. 3: Disclosure the alternative display unit without any compartment to help the installation to the footwear material.

FIG. 3A-3D: Disclosure the variety of the LED button light with heart, flower, jewelry, dolphin design with the nice shape and lit areas with build-in IC chip inside.

FIG. 4A-4E: Disclosure the basic construction of the LED button lights (Prior Arts).

FIG. 5: Disclosure the 2nd embodiment disclosure the button LED(s) light kits with details of the construction with the plurality of LED(s) on the display unit surface with the clear epoxy to sealed the build-in integrated circuit (hereafter as IC) to drive the LED(s).

FIG. 5-1: Disclosure the different construction for small display surface so can simple install on the non-lighted display unit which will increase a lot of value by the non-lighted display unit such as flower, jewelry type etc.

FIG. 5-2 and 5-3: Disclosure the other designs for LED button light kits for flower designs.

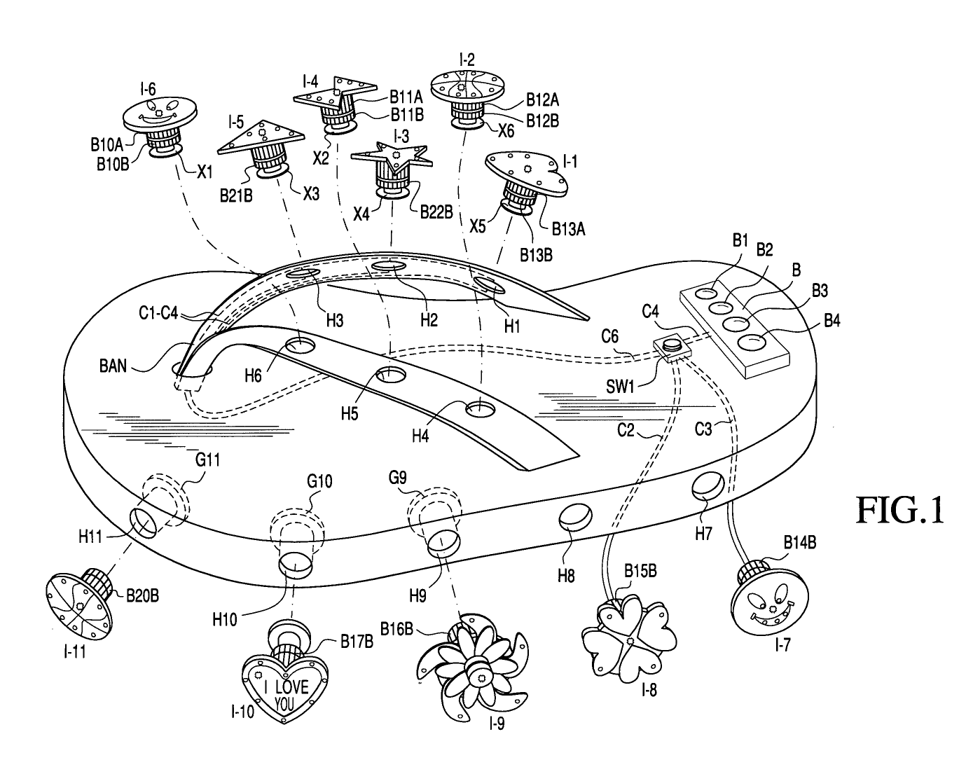

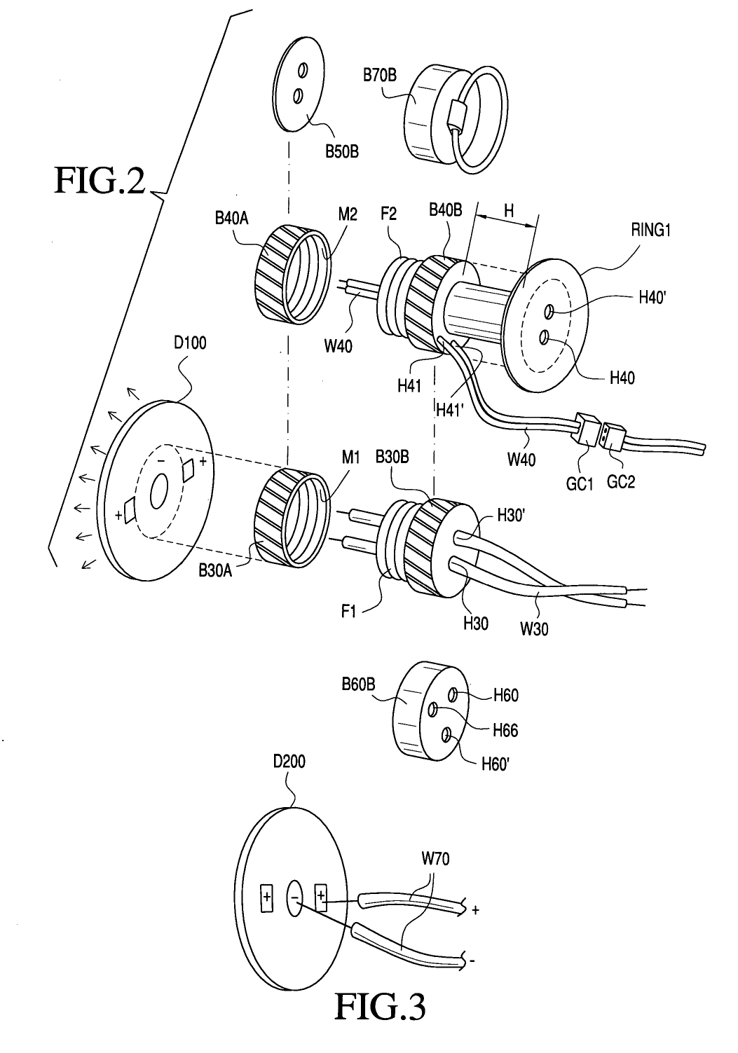

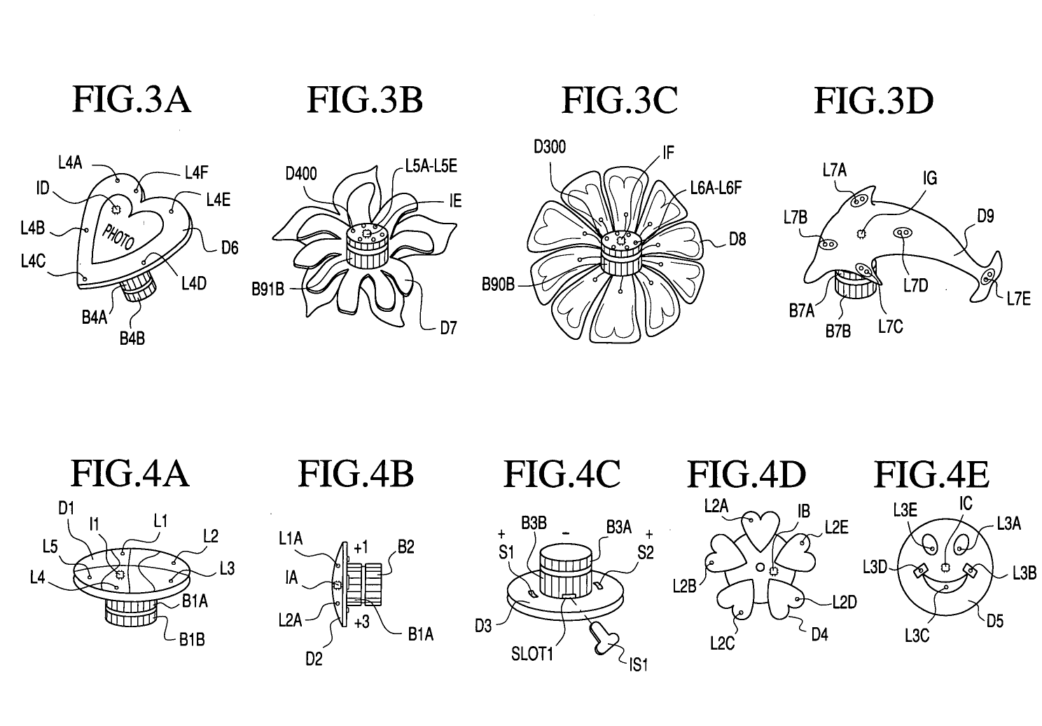

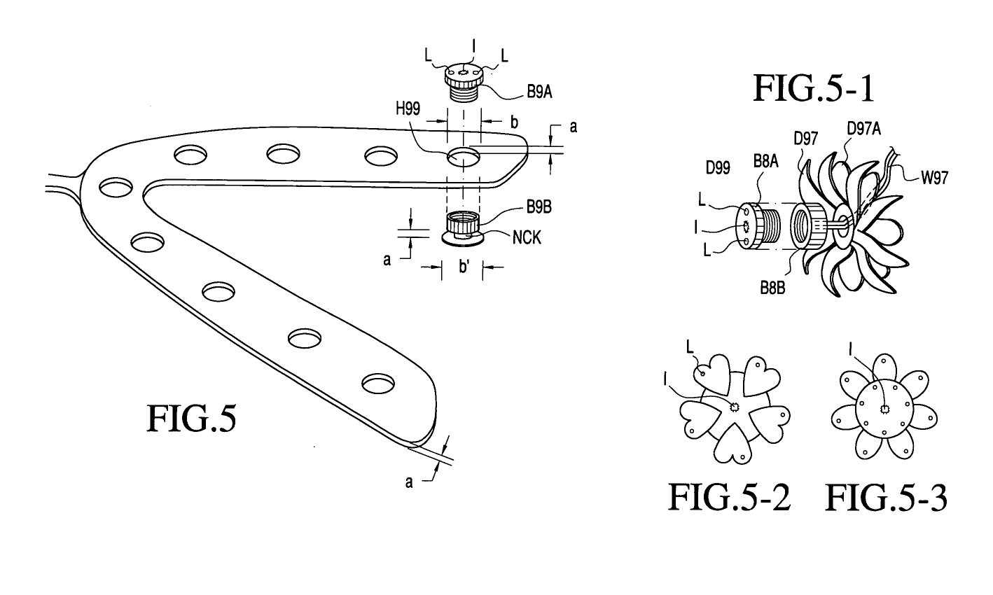

### DETAIL DESCRIPTION OF THE PREFERRED EMBODIMENTS

The current invention mainly has the several technical to create the best LED(s) light kits for Footwear applications. The basic technical including
(1) LED button light construction with rigid or flexible of printing circuit board
(2) Dice or Chip type of LED(s)
(3) build-in integrated circuit for LED(s) preferred functions with trigger means by press sensitive switch controlled by the weight applied to the said switch
(4) Proper sealing method applied to seal the LED(s) to make good appearance and cosmetic value
(5) Super thin and compact size for the light unit
(6) Sealing means and process for wiring
(7) Simple installation for any location of footwear

The U.S. prior art including Roger's U.S. Pat. No. 4,848,009, U.S. Pat. No. 5,343,190 and Weng's U.S. Pat. No. 5,663,614, and Wei's U.S. Pat. No. 6,525,487 and Anterby's U.S. Pat. No. 6,280,045,U.S. Pat. No. 6,354,712 and Wut's U.S. Pat. No. 6,104,140, U.S. Pat. No. 5,909,088, U.S. Pat. No. 5,866,987 and Goldston's U.S. Pat. No. 5,303,485, U.S. Pat. No. 5,546,681 and other prior arts including the U.S. Pat. Nos. 5,033,212, 5,329,432, 5,394,312, 5,371,662, 5,438,488, 5,456,032, 5,457,900 did not apply the dice or chip size LED(s) on the flexible Printing circuit or did not incorporated with the current invention for push on and off switch to trigger the IC to create the light functions. The prior art have bulky and big traditional LED lacking of the flexible printing circuit board (or the equivalent function basic substrate). The motion switch also created the power consumption during the delivery process to cause the power wasted. The current invention making big upgrade for the technical basing on new LEDs and brighter LED come out so can make all these improvements of all these prior arts.

Basing on these features can created the best flexible LED(s) light kits for footwear application as follow introduction details features with details description

From FIG. (4-A) disclosure the conventional LED button light's construction. The display surface (D1) have plurality of LED (L1)(L2)(L3)(L4)(L5) and IC chip (I1) with the colorful artwork, indicia on the surface and sealed by epoxy sealing to make it up to environment protection. The display (D1) is a printing circuit board (hereafter as PCB and it can be made of rigid or soft material and this depend on the requirement. The PCB it has the pre-arranged electric terminals to allow the power source can supply electricity into the IC and make the plurality of dice LEDs to make desired light function. This is great feature to apply to any kind of footwear because it has nice Display area with shaped and simple wiring and connection terminal.

From FIG. (4-B) disclosure the side-view of the LED button light construction. The display (D2) included with build-in dice LEDs and IC chip on the front surface. The back surface has two terminals (+1) (+2) to connect with positive pole of the power source away from the center area and the center have one terminal (not shown) to connect with negative pole of power source. This embodiment disclosure the power source is batteries and use two cylinder type compartments (B1A) (B1B) to hold the batteries and make the electric connection to turn on the all LEDs (L1A) (L2A) though IC chip (IA) to control the desired light functions.

From FIG. (4-B) disclosure the side-view of the LED light construction. The Battery compartment is made by two metal cylinder tube (B3A) (B3B) which can solder with the Display (D3) back surface terminals (+S1) (+S2). The batteries can load inside of the cylinder compartments (not shown). The cylinder can add a open-slot (SLOT1) and can put a isolate-tab (IS1) into to make sure the power source do not have consumption.

From FIG. (1) disclosure the back-view of cylinder holes (H1) (H2) (H3) (H4) (H5), and (H6) arranged on the sandal upper band. There have a lot of cylinder holes (H7) (H8) (H9) (H10) (H11) on the side wall of sandal's side wall. The LED light kit (1-7) (1-8) (1-9) (1-10) (1-11) can insert into all these cylinder holes. The fix means can applied to hold the Button light do not separate with footwear, it can use glue, edge ring, rivet, soldering, screw to make the security hold all these light. The light kits (1-7) and (1-8) have wires (C3) (C4) to solder on the cylinder compartments (B14A) (B14B) and (B15A) (B15B) to get the power source from the power source which are install internal of shoe outsole. This is one of the applications which should not limit the current invention scope for the installation. The alternative method as light unit (1-9) (1-10) (1-11), each light unit has its owned power source inside the cylinder compartment so do not use the extra conductive wires to hook with other power source. Same application for the shoe upper band installation for the holes (H1) (H2) (H3) (H4) (H5) (H6) for the light unit (1-1) (1-3) (1-5) (1-2) (1-4) (1-6) but the cylinder compartment is special design as the base (B13B) (B22B) (B21B) (B12B) (B11B) (B10B) which have a neck space to allow the shoe upper band thickness can be fit into the neck. The neck bottom is bigger diameter (x5) (x4) (x3) (x6) (x2) (x1) so can prevent from uncomfortable wearing and prevent from pulling out easily by consumer.

The light unit (1-1)(1-3) (1-5) (1-2) (1-4) (1-6) can be build-in batteries or use the conductive wires to solder together with cylinder compartments as above discussion. The shoe upper band (BAN) can also have the conductive wires (C1-C4) within to make electric connection with light units and get the power from the remote battery box (BB) by wires (C6). To prevent from the light unit (1-9) (1-10) (1-11) easily to pull out can have groove (G9) (G10) (G11) to hold the light unit to prevent from the pull out easily.

From FIGS. (4-D)(4-E)(3-A)(3-B)(3-C)(3-D) disclosure all different designs for the light kits for flower, smile face, heart, 3 layers flower, 2 layers flower, dolphin so these will have very eye-catching light kits for footwear.

From the FIG. (2), the preferred embodiment 1 which disclosure the different light unit arrangement with different cylinder compartment (B30U) (B30B) is the standard size. The cylinder compartment (B30U) offer a solder substrate to allow the Display (D100) can be security hold on this cylinder compartment and build the electric delivery while the wires (W30) soldered on the Display back surface terminals end (−100)(+100). Because IC chip is already installed on the display (D100) for this embodiment so only need connect the wires (W30) with switch and power source so the Display (D100) can have the desired light functions. This embodiment can connect with a lot of light kits as display (D100) for plurality units and each one have its owned IC chips for different timing, duration time, flashing functions so totally different with the Roger's '009, Weng's '614, Wei's '487, Anterby's '045 patents because each of prior art did not use a display for plurality of dice-type LEDs on a display unit with build-in IC chip. The current invention has these unique features with the most perfectly light effects than all prior arts.

From FIG. (2), disclosure the different combination for the cylinder compartment and construction. The Upper compartment can see the compartment (B30U) is a standard unit and made out of metal unit so can direct solder with the terminals (+100) (+100′) for two position so can hold the display unit (D 100) security. The Compartment for upper may not necessary for some application for example the compartment (B50B) is not need the upper part, only a super slim metal bottom part needed for soldering because no need put batteries inside the compartment inside of this application. The Display (D100) may be directly soldered the conductive wire to get the power source.

From FIG. (2) disclosure the compartment and length which depend on the hole's size. The neck (N8) has the bottom Ring (Ring 1) which is to help the light unit to hold on the band as FIG. (1) Band (BAN) installation. The bottom ring (Ring1) is much bigger than the cylinder body diameter because the bottom will sit into the hole but need certain neck to allow the shoe layer's thickness to fit the neck. This is very good design to install the button light on the shoe material by this design. The wire (W40) also can use quickly connector sets (QC1) (QC2) to make the connection with switch and power source.

From FIG. (2), other compartment (B70B) with a hook attached on the bottom compartment so this can let the light kits with alternative installation to footwear.

From FIG. (2), The compartment (B60B) have 3 holes, one hole (H66) on the center is for rivet installation. The two side holes (H60) (H60′) for wire passing though. This is alternative arrangement for certain footwear application.

From the FIG. (3) disclosure the alternative and simple electric connection of display unit (D200) with back terminals (+200) (+200′) and negative (−200) by conductive means here is the wire (W70). This is the alternative method for simple and quickly arrangement for the light install on the footwear. These kind of light kits lack of the compartment help so need to use the traditional attach means to install on the shoe material such as glue, solvent, stitch, envelope, pocket, underlay, and other available attachment method to install the display unit on the shoe material security.

From the FIG. (3-C) (3-B) disclosure the light kits with a super small display unit (D300)(D400) have the non-lighted flower part for decorative purpose. The small display unit (D300) (D400) still have the build-in IC and circuit system and plurality of LEDs, he compartment bottom (B90B) (B91B) can be soldered on the non-lighted display flower (D8) (D7) or use the glue, solvent, rivet, melt to fix the light units on the display D8) (D7).

From FIG. (5) disclosure the special cylinder compartment (B9B) fixed into the beach sandal's shoe upper hole (H99), the hole with (b) diameter, the compartment bottom diameter (b′) is much bigger than the (b) diameter so can prevent from the people pull out from the shoe upper band. Also, the neck (NCK) have the diameter same as the hole (H99), so the shoe upper can fit into the neck (NCK) tightly. The neck length (a′) is identical with shoe upper band's thickness (a), so the shoe upper band will tightly fit into inside the neck. The bottom of the neck with (b′) diameter is much bigger than the hole's (b) diameter. This will let the wearer have very flat skin touch and feel comfortable.

From FIG. (5-1) disclosure details for the small display unit (D99) which have small display area for IC and circuit system and plurality of dice-type LEDs. The compartment (B8B) which have a round base and can soldering or glue with the non-lighted display part (D97)(D97A) which may a flower, jewelry designs with center hole for the wires (W97) and rivet process to the non-lighted display part (D97) (D97A).

From FIG. (5-2) and FIG. (5-3) disclosure the big display unit for current invention. The LEDs are on the big surface with build-in IC and circuit system and Dice-type LEDs. The compartment of lower area can be designed basing on marketing requirement. From all discussion above listed, the compartment can be belong to a part of the conductive means. The preferred compartment can help to hold the display unit so easily to install on the shoe material. Some application basing on the space limitation or other consideration, the compartment is not allow adding to the display unit, so the display unit has to directly connect with wires to connect with switch and power source. This still keep the splendid display surface with proper function only need to find other attachment means to install the display unit on the shoe compartment.

Although, above preferred embodiments of the invention have been described in details. It will be appreciated that the scope of the invention is not to be limited to the described embodiments, but rather that the invention is to be interpreted in accordance with the appended claims.

I claim:

1. A Button LED light kits for footwear incorporated:
At least one display unit having at least two of surface including 1^{st} and 2^{nd} surface, the 1^{st} surface with plurality of dice-type or chip-type of LEDs with Build-in IC and circuit system and the 2^{nd} surface with electric terminals to solder with conductive means and make the electric signal delivery from the power source to the IC chip and circuit system to drive the said LEDs for desired illumination.
At least one switch means to make connection and disconnection of the power source.
At least one power source which supply the power to the IC and circuit system.
The improvement included:
At least one of compartment means is part of the said conductive means to supply the installation for said display to footwear.

2. The button LED light kits for footwear as claimed as claimed in claim 1, the one switch can work with plurality of the said button light units and each button light units have its own build-in IC chip and circuit system on the said display surface for its own functions.

3. The button LED light kits for footwear as claimed as claimed in claim 1, the said display unit has its own color, indicia, art work, design, painting, drawing, logo, trademark on the said display surface to make the display with colorful appearance.

4. The button LED light kits for footwear as claimed as claimed in claim 1, the said LEDs may be selected from the group of number, shape, illumination, dimension, colors, size, seal treatment, and connection means.

5. The button LED light kits for footwear as claimed as claimed in claim 1, the said integrated circuit (IC) can have any combination of conventional functions incorporated the press sensitive switch as a trigger means to drive the said IC and circuit system for light function(s).

6. The button LED light kits for footwear as claimed as claimed in claim 1, the said compartment means fix with the display unit may selected from the group combination of glue, solvent, chemicals, hot sealing, snap, press tight, ultrasonic sealing, double side, tape, solder, join together, and rivet to make the join together compartment with the display unit or join together compartment with the non-lighted display unit for desired construction to have pretty appearance.

7. The button LED light kits for footwear as claimed as claimed in claim 1, the said footwear may have plurality of the button lights units for preferred location.

8. The button LED light kits for footwear as claimed as claimed in claim 6, the said plurality of button lights, each of the buttons light has its own power source and install on desired location of footwear.

9. The button LED light kits for footwear as claimed as claimed in claim 1, the said IC incorporating a time counting and stop the circuit system power source if the light duration time is over pre-determined time period.

10. The button LED light kits for footwear consist of:
At least one display unit having at least two of surface including 1^{st} and 2^{nd} surface, the 1^{st} surface with plurality of dice-type of LEDs with Build-in IC and circuit system and the 2^{nd} surface with electric terminals to solder with conductive means and make the electric signal delivery from the power source to the IC chip and circuit system to drive the said LEDs for desired illumination and functions.
At least one switch means to make connection and disconnection of the power source.
At least one power source which supply the power to the IC and circuit system.

11. A footwear have plurality of Button LED light kits consist of:
The footwear has at least two pieces of button LED light kits and each of button-light kit consist of:
At least one display unit having at least two of surface including 1^{st} and 2^{nd} surface, the 1^{st} surface with plurality of dice-type of LEDs with Build-in IC and circuit system with and the 2^{nd} surface with electric terminals to solder with conductive means and make the electric signal delivery from the common remote power source to the each of IC chip and circuit system to drive the said each of the button light kits for desired illumination and functions.
At least one common switch means to make connection and disconnection of the power source.
At least one of common power source which supply the power to the IC and circuit system.
The improvement included:
The each of button light kits has its own display unit with preferred design and indicia on the said display surface.
